(19) United States
(12) Patent Application Publication
(10) Pub. No.: US 2021/0053810 A1
(43) Pub. Date: Feb. 25, 2021

(54) PUNCTURE DEVICE TO OPEN VACUUM JARS

(71) Applicant: Glen Roger Evans, Wayne, NJ (US)

(72) Inventor: Glen Roger Evans, Wayne, NJ (US)

(21) Appl. No.: 16/947,708

(22) Filed: Aug. 13, 2020

Related U.S. Application Data
(60) Provisional application No. 62/889,411, filed on Aug. 20, 2019.

(51) Int. Cl. B67B 7/20; B26F 1/32; B26F 1/24; B67B 7/00

(52) U.S. Cl. CPC B67B 7/20; B67B 7/24; B26F 1/24; B26F 1/32

(57) ABSTRACT

The present invention provides a lid puncture device having a hemispheric main body, a resilient compressible component, a flexible magnetic disk, and a piercing pin. The hemispheric main body has a domed surface and a flat surface. The flat surface of the main body has a recessed region surrounding a central pillar. The resilient compressible component is housed within and attached to the recessed region of the hemispheric main body. The flexible magnetic disk is attached to the resilient compressible component. The piercing pin is attached to the hemispheric main body and held axially within the central pillar. A process of opening a vacuum-packed jar with the lid puncture device is also provided. The process includes placing the flexible magnetic disk of the lid puncture device onto a lid of the vacuum-packed jar and striking the domed surface.

### CROSS-REFERENCE TO RELATED APPLICATION

This application claims the benefit of priority of U.S. provisional application No. 62/889,411, filed Aug. 20, 2019, the contents of which are herein incorporated by reference.

### BACKGROUND OF THE INVENTION

The present invention relates to devices to open vacuum jars and, more particularly, to devices that puncture the lids of the vacuum jars.

Certain jars and containers with metal lids are difficult to open because the vacuum inside the container forces the lid against the opening of the container.

Existing devices solve the problem in several ways. Some devices apply a greater twisting force to overcome the downward pressure caused by the vacuum. Other devices attempt to increase a person's ability to grip the container lid to avoid hand slippage while twisting the lid. These devices often fail because the hand holding the container is often not strong enough to avoid slipping when subjected to the extra twisting forces. A third type of device releases the vacuum by prying or forcing the jar lid seal away from the rim of the container. These devices are often ineffective due to a large variety of jar lid measurements. These devices require simultaneous use of two hands and at least moderate strength to hold the container and the device.

Some devices pierce a jar lid but require two hands to operate. For example, United States Publication No. 2019/0185307 to Stude discloses a piercing element that extends past the housing even when not in use and cannot rest stably on a jar lid. Similarly, U.S. Pat. No. 9,889,958 to Roefs discloses a piercing element that extends past the base in rest. Other devices are complex, and therefore costly, and are designed such that they experience mechanical failure after repeated use. United States Publication No. 2006/0236552 to Giles discloses a complicated mechanism that requires several parts and appears to fully compress the spring, resulting in fatigue and failure over time. Moreover, the Giles device provides a rigid flat element to rest on an often-concave jar lid surface, likely causing the Giles device to lose its grip and requiring two-handed operation.

As can be seen, there is a need for a simple, durable device that releases a lid from a vacuum jar easily with one hand.

The present invention provides a device operable to puncture a hole through the metal lid of a jar, allowing air to enter the jar, eliminating the vacuum, and releasing the downward pressure of the lid. This reduces the effort needed to twist open the lid. The inventive device allows a person with even minimal hand strength to release the vacuum inside a container, using only one hand and a light tap.

### SUMMARY OF THE INVENTION

In one aspect of the present invention, a lid puncture device is provided comprising: a hemispheric main body having a domed surface and a substantially planar surface, said substantially planar surface having a recessed region surrounding a central pillar; a resilient compressible component housed within the recessed region and attached to the hemispheric main body; a flexible magnetic disk attached to the resilient compressible component; and a piercing pin attached to the hemispheric main body and held axially within the central pillar.

In another aspect of the present invention, a process of opening a vacuum-packed jar with the lid puncture device is provided, comprising placing the flexible magnetic disk of the lid puncture device onto a lid of the vacuum-packed jar and striking the domed surface.

These and other features, aspects and advantages of the present invention will become better understood with reference to the following drawings, description, and claims.

### BRIEF DESCRIPTION OF THE DRAWINGS

FIG. 1 is a perspective view of a vacuum release punch according to an embodiment of the present invention;

FIG. 2 is a bottom perspective view thereof;

FIG. 3 is a perspective view thereof;

FIG. 4 is a sectional view taken along line 4-4 of FIG. 2;

FIG. 5 is an exploded view thereof;

FIG. 6 is a sectional view taken along line 6-6 of FIG. 1;

FIG. 7 is a detailed sectional view thereof shown positioned for use;

FIG. 8 is a detailed sectional view thereof, shown in use; and

FIG. 9 is a detailed sectional view thereof, shown after use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

“Consisting essentially of” and like terminology refers to the recited components and excludes other components which would substantially change the basic and novel characteristics of the article. Unless otherwise indicated or readily apparent, a device consists essentially of the recited components when the article includes 90% or more of the recited components. That is, the terminology excludes more than 10% unrecited components.

As used herein, the term “substantially planar surface” means that the device has a surface that is not flat all the way across (i.e., portions have been removed from the surface), but the portions of the surface that have not been removed lay flat on a planar surface.

Broadly, one embodiment of the present invention is a puncture device to open vacuum jars, comprising a hemispheric main body; a resilient compressible component with a flexible magnetic disk attached thereto, and a piercing point. The hemispheric main body may have a domed surface and a generally planar surface. The generally planar surface may have a recessed region surrounding a central pillar. The resilient compressible component is generally housed within the recessed region of the hemispheric main body. The piercing point may be held axially within the central pillar of the hemispheric main body.

The inventive puncture device does not require a base, a spring, a plunger, or a compressible housing to be operative in opening vacuum-sealed jars. The device preferably lacks a base, a spring, a plunger, and a compressible housing, as these components make manufacture of a puncture device more complicated and more expensive.

The recessed region within the hemispheric main body may be a groove with a generally flattened torus conformation. Preferably, the hemispheric main body provides the device with a low center of gravity, allowing activation with an easy tap instead of requiring the user to press on the device.

The compressible component may be attached with adhesive to the interior of the hemispheric main body, within the recessed region. This adhesive may sometimes be referred to herein as the first adhesive layer. Preferably at least 50% of the compressible component volume is housed therein, limiting compression to less than 50% to reduce fatigue and delay failure. In other words, a ratio of a depth of the recessed region to a height of the resilient compressible component is at least about 0.5:1 and less than 1:1. Moreover, the central pillar within the hemispheric main body may limit the stroke during use and thus limit compression of the compressible component.

The flexible magnetic disk may be attached with adhesive to the compressible component on a surface opposite the hemispheric main body. This adhesive may sometimes be referred to herein as the second adhesive layer. When not in use, the flexible magnetic disk may provide a convenient way to store the device on any magnetic surface, e.g. a refrigerator. In use, the flexible magnetic disk may secure the puncture device in position on a metal jar top. Preferably, the magnetic disk does not extend radially past the outer circumference of the groove in the hemispheric main body. As the magnetic disk is flexible and not supported by a rigid structure, the disk may conform to a lid that is concave due to the vacuum within the jar, better stabilizing the device.

The piercing point may be a piercing pin and may be attached within the central pillar of the hemispheric main body, by way of a friction fit, an adhesive, or a combination thereof.

The materials of manufacture are not particularly limited. The hemispheric main body may be injection molded using a durable shatterproof plastic. The hemispheric main body may have a diameter of about 0.875″ to about 3.500″, such as about 1.750 inches in diameter.

The resilient compressible component may be a foam cylinder die cut or laser cut from a sheet of open-cell polyurethane foam. In that case, the sheet of polyurethane foam may have a thickness of about 0.250″ to about 1″, such as about 0.500-inch-thick. The compressible component may have a diameter of about 0.625″ to about 2.50″, such as about 1.25 inches in diameter, and may have a hole in the center, to accommodate the central pillar, of about 0.250″ to about 1″ in diameter, such as about 0.500 inches in diameter.

The flexible magnetic disk may be die cut from a sheet of flexible magnetic material. The flexible magnetic material may be from about 0.040″ to about 0.160″ thick, such as about 0.080 inches thick. The flexible magnetic disk may have a diameter of about 0.625″ to about 2.50″, such as about 1.25 inches in diameter. The flexible magnetic disk may have a hole in the center of the disk to accommodate the piercing point with a diameter of about 0.125″ to about 0.500″, such as about 0.250 inches in diameter.

The piercing point may be made from metal, such as hardened wire or drill stock. In that case, a suitable gauge for hardened wire may be about 0.050″ to about 0.200″, such as about 0.100 inches. For example, the piercing point may be hardened steel, with a hardness in the range of 57-65 Rockwell hardness, C scale (HRC). The piercing point may be about 0.375″ long to about 1.500″ long, such as about 0.750 inches in length. The piercing point may have one flat end and one pointed end, with a diameter from about 0.050″ to about 0.200″, such as about 0.100-inch in diameter.

The puncture device may be assembled by gluing the resilient compressible component, e.g., a foam cylinder, into the corresponding groove in the hemispheric main body such that the piercing point may be centered within the hole in the foam cylinder. The metal piercing point may be press fit into a corresponding hole at the center of the central pillar. The flexible magnet may be glued to the outer flat surface of the foam cylinder, with the central hole aligned with the central hole in the foam cylinder.

To use the inventive puncture device, the device may be positioned, magnet side down, on top of the lid of a container to be opened. The user may tap the domed area of the hemispheric main body with the palm of one hand, puncturing a small hole in the lid. Most lids make a noise and lift as air enters the container and the vacuum releases, signaling successful use. The device may be removed from the lid, which may then be easily twisted open.

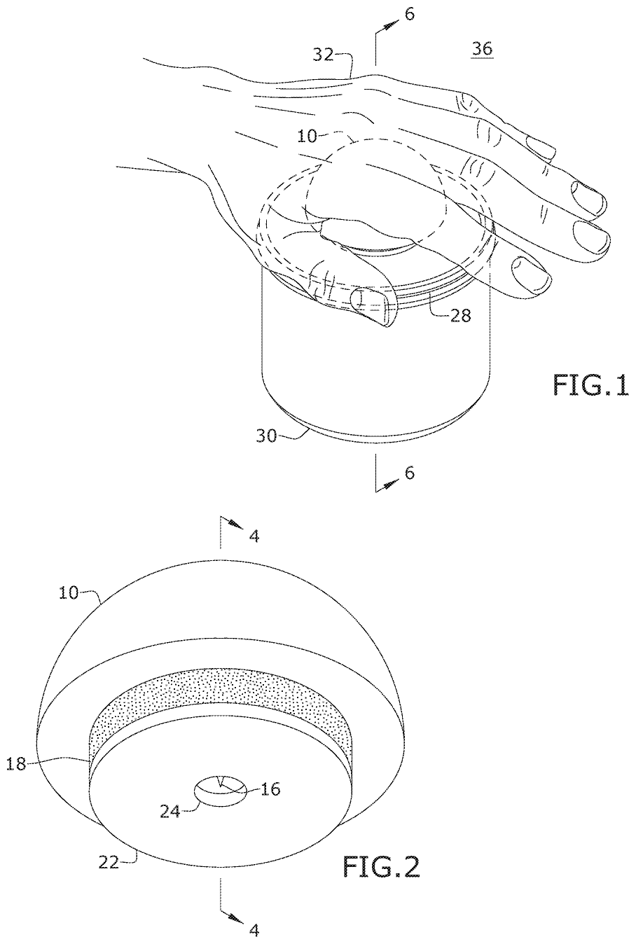

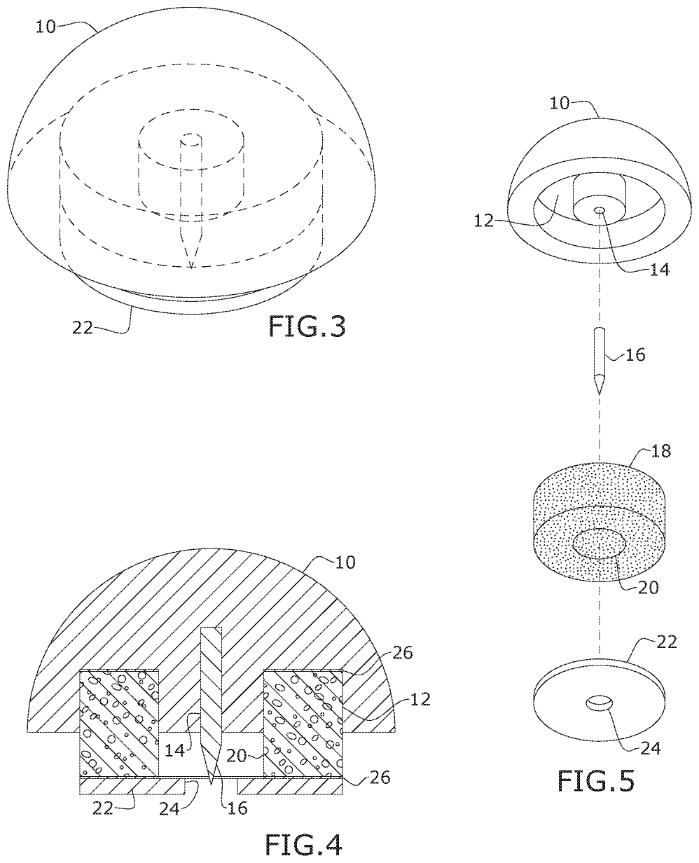

Referring to FIGS. 1-9, FIG. 1 shows a hemispheric body 10 of a puncture device according to an embodiment of the present invention, in use, positioned on top of a jar lid 28 on a jar 30, with a user 32 tapping the body 10. The ambient atmosphere 36 surrounds the user 32, the device, and the jar 30. As shown in FIG. 2, the puncture device further comprises a foam component 18 attached to a flexible magnetic disk 22, and a piercing pin 16 extendable through an opening 24 in the flexible magnetic disk 22. The hemispheric body 10 is configured to provide a predetermined location for the foam 18 and a predetermined location for the piercing pin 16. FIGS. 3-5 illustrate the components of the inventive puncture device. The body 10 is formed with a recess opening or groove 12 and the foam component 18 may be affixed therein with an adhesive 26. The flexible magnetic disk 22 may be secured to the foam component 18 by a suitable method, such as an adhesive layer 26. An opening 14 in the center of the body 10 securely holds a piercing pin 16. Both the foam component 18 and the flexible magnetic disk 22 have an opening 20, 24 through which the piercing pin 16 may pass. When at rest, the foam component 18 and the flexible magnetic disk 22 extend beyond the bottom of the hemispheric body 10 such that the piercing pin 16 does not extend past the magnetic disk 22.

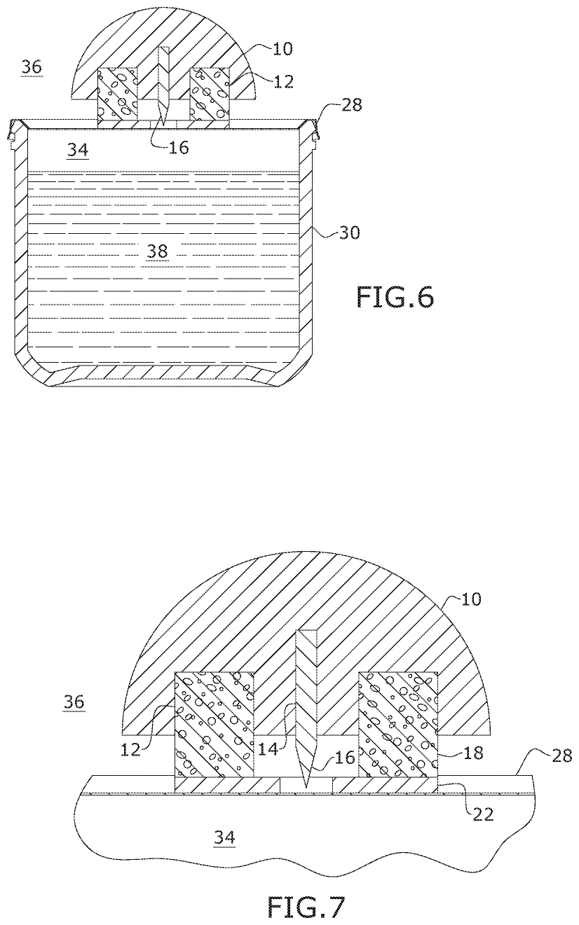

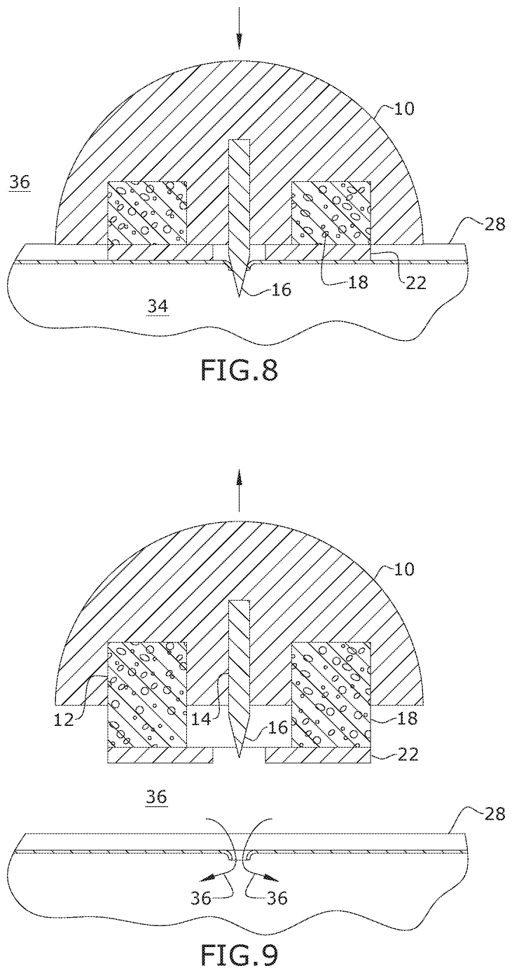

FIGS. 6-9 illustrate the inventive puncture device in use on a jar 30 with the contents 38 under vacuum 34. The flexible magnetic disk 22 may hold the device in position on the jar lid 28, as shown in FIGS. 6 and 7. When the user taps the body 10 of the device as shown in FIG. 8, the foam component 18 is compressed, driving the piercing pin 16 through the openings 20, 24 in the foam 18 and the magnetic disk 22 and through the jar lid 28. As shown in FIG. 9, as the foam 18 decompresses, the piercing pin 16 is removed from the jar lid 28, allowing the ambient atmosphere 36 to enter the jar 30, filling the vacuum 34.

It should be understood, of course, that the foregoing relates to exemplary embodiments of the invention and that modifications may be made without departing from the spirit and scope of the invention as set forth in the following claims.

What is claimed is:

1. A lid puncture device comprising:
a. a hemispheric main body having a domed surface and a substantially planar surface, said substantially planar surface having a recessed region adjacent a central pillar;
b. a compressible component housed within the recessed region;
c. a magnetic disk attached to the compressible component; and
d. a piercing pin attached to the hemispheric main body and held axially within the central pillar.

2. The lid puncture device of claim 1, wherein the magnetic disk does not extend radially past an outer circumference of the recessed region.

3. The lid puncture device of claim 1, wherein both the compressible component and the magnetic disk have a central opening aligned with the piercing pin.

4. The lid puncture device of claim 3, wherein when the compressible component is compressed, the piercing pin extends through the central openings of the compressible component and the magnetic disk.

5. The lid puncture device of claim 1, further comprising a first adhesive layer attached to the recessed region and the compressible component and a second adhesive layer attached to the compressible component and the magnetic disk.

6. The lid puncture device of claim 5, wherein both the compressible component and the magnetic disk have a central opening aligned with the piercing pin; the piercing pin extends past the substantially planar surface; and the magnetic disk does not extend radially past an outer circumference of the recessed region.

7. The lid puncture device of claim 1, wherein the piercing pin extends past the substantially planar surface.

8. The lid puncture device of claim 1, wherein a ratio of a depth of the recessed region to a height of the compressible component is at least about 0.5:1 and less than 1:1.

9. The lid puncture device of claim 1, wherein the lid puncture device is operative to puncture a lid absent a spring and a compressible housing.

10. A process of opening a vacuum-packed jar, comprising placing the magnetic disk of the lid puncture device of claim 1 onto a lid of the vacuum-packed jar and striking the domed surface.
